(19) United States
(12) Patent Application Publication
(10) Pub. No.: US 2024/0292242 A1
(43) Pub. Date: Aug. 29, 2024

(54) BROADBAND BACKUP VIA BOOTSTRAP

(71) Applicant: AT&T Intellectual Property I, L.P., Atlanta, GA (US)

(72) Inventor: Jason Sikes, Carnation, WA (US)

(73) Assignee: AT&T Intellectual Property I, L.P., Atlanta, GA (US)

(21) Appl. No.: 18/174,116

(22) Filed: Feb. 24, 2023

(51) Int. Cl. H04W 24/04; H04W 76/10

(52) U.S. Cl. CPC H04W 24/04; H04W 76/10; H04W 84/12

(57) ABSTRACT

Aspects of the subject disclosure may include, for example, establishing a local area connection with one or more devices including a home gateway, the home gateway configured to access data services over a broadband network, receiving an indication that the data services over the broadband network are unavailable, initiating a cellular network connection with a cellular network using a Bootstrap embedded subscriber identity module (eSIM) service of the wireless device to access the cellular network, and providing backup data services to the one or more devices over the cellular network according to the Bootstrap eSIM service. Other embodiments are disclosed.

### FIELD OF THE DISCLOSURE

This disclosure relates generally to providing backup service to a broadband device during a service outage.

### BACKGROUND

Many premises including residences receive broadband telecommunication service. Such service generally involves customer premises equipment (CPE) which connects to a broadband network to communicate content and other information. Such service may be delivered via a fiber optic link, a digital subscriber line (DSL), coaxial cable, a satellite link or a fixed wireless link, for example. The broadband service may experience service interruptions which can impact, for example, a customer's home internet service.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for providing a backup service or connection for a broadband network connection to a premises such as a residence of a customer. Some mobile devices are equipped with an embedded Subscriber Identity Module (eSIM) device. In some embodiments, a mobile device equipped with an eSIM may provide a backup connection to broadband services using the eSIM and access to a wireless network. Other embodiments are described in the subject disclosure.

One or more aspects of the subject disclosure include establishing a local area connection with one or more devices including a home gateway, the home gateway configured to access data services over a broadband network, receiving an indication that the data services over the broadband network are unavailable, initiating a cellular network connection with a cellular network using a Bootstrap embedded subscriber identity module (eSIM) service of the wireless device to access the cellular network, and providing backup data services to the one or more devices over the cellular network according to the Bootstrap eSIM service.

One or more aspects of the subject disclosure include initiating a wireless local area network with one or more devices, providing broadband data services to the one or more devices over the wireless local area network, wherein the providing broadband data services comprises communicating data with a broadband network, and identifying a failure in the communicating data with the broadband network. Aspects of the subject disclosure further include automatically initiating a hotspot connection with a wireless device and providing backup broadband services to the one or more devices over the wireless local area network from the hotspot connection with the wireless device, wherein the wireless device is operative to establish a cellular network connection with a cellular network using a Bootstrap embedded subscriber identity module (eSIM) service of the wireless device to access the cellular network.

One or more aspects of the subject disclosure include establishing, by a wireless device, a hotspot network with one or more devices including a home gateway, the home gateway configured to access broadband data services over a broadband network, receiving, from the home gateway, an indication that the broadband data services are unavailable and accessing a Bootstrap eSIM of the wireless device, wherein the accessing the Bootstrap eSIM is responsive to the receiving the indication that the broadband data services are unavailable. Aspects of the subject disclosure further include initiating a cellular network connection with a cellular network, wherein the initiating the cellular network connection is based on information of the Bootstrap eSIM providing backup data services from the cellular network to the home gateway over the hotspot network.

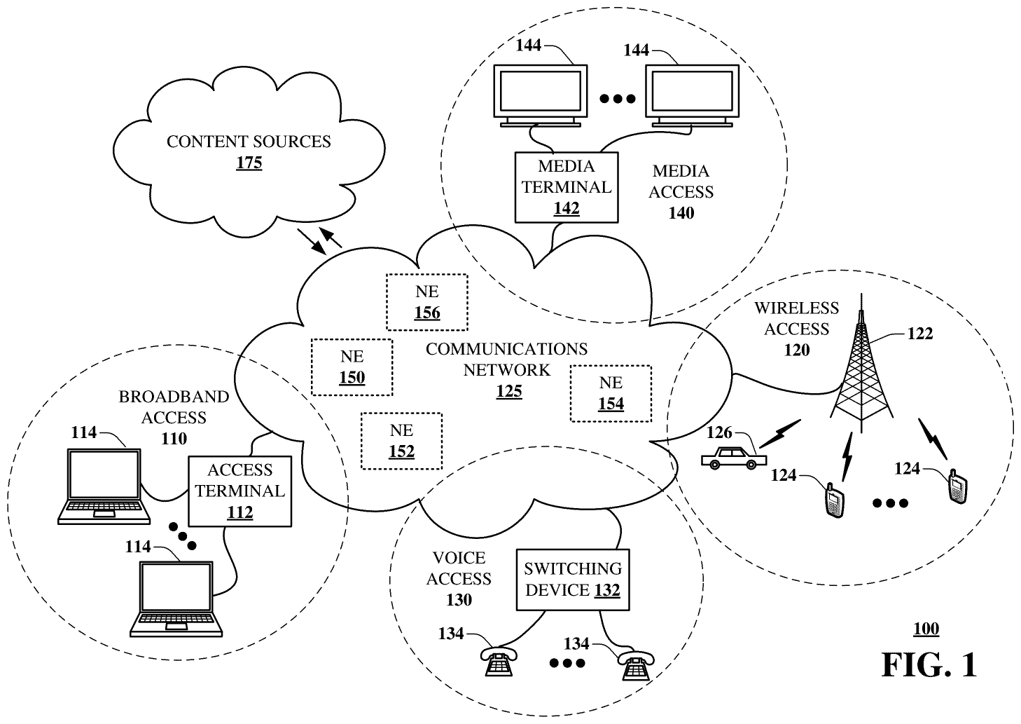

Referring now to FIG. 1, a block diagram is shown illustrating an example, non-limiting embodiment of a system 100 in accordance with various aspects described herein. For example, system 100 can facilitate in whole or in part using a Bootstrap eSIM of a wireless device to provide backup data services to a home gateway when a broadband network serving the home gateway becomes unavailable. The use cases for the Bootstrap eSIM conventionally include providing authorization information to a network for a cell phone or other wireless device upon initial activation of the cell phone. The use cases for the Bootstrap eSIM can be extended to providing a data connection to the cellular network for times when the broadband connection to a home gateway is unavailable. The home gateway accesses the cell phone over a hotspot connection. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VOIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VOIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

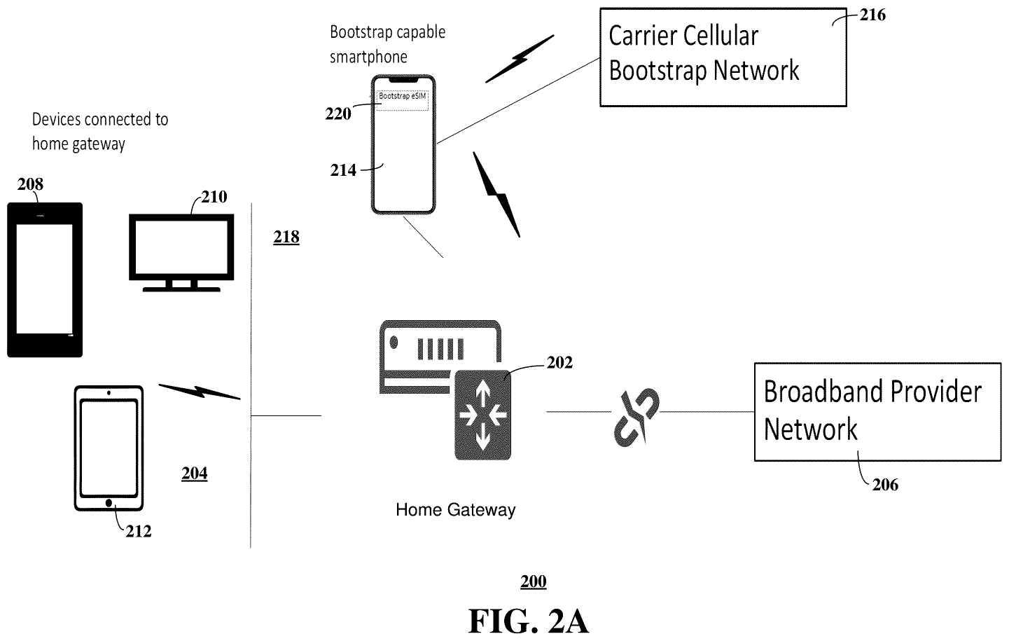

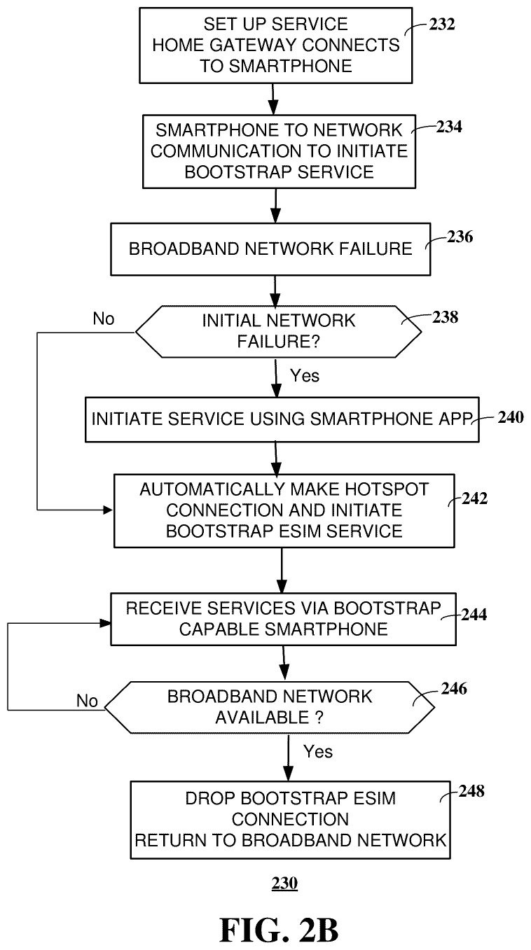

FIG. 2A is a block diagram illustrating an example, non-limiting embodiment of a system 200 functioning in association with the communications network 125 of FIG. 1 in accordance with various aspects described herein.

Broadband service (fiber, DSL, cable, satellite, fixed wireless, etc.) can have service interruptions which can impact a customer's home internet service. Cellular capability built into the home gateway, which includes a modem and a router, can provide a backup service for broadband service interruptions However, such integrated products are expensive, and have limited cost/benefit for a capability that may never be used. Separately, with the industry transition to eSIM, smartphone manufactures are including embedded cellular capability in the devices to enable download and setup of the eSIM over cellular when Wi-Fi is not available. This capability is termed bootstrap service, and while the initial intent of this capability is for download of an eSIM, this embedded cellular capability can be utilized for additional use cases. In accordance with aspects described herein, a system and method provide a cellular backup service for home broadband via the embedded bootstrap capability in some smartphones. Benefits include restoring internet service, allowing a customer to continue to stream video, browse, and have overall internet connectivity. When the broadband service is restored, the cellular back via bootstrap can be disabled automatically. Embodiments will greatly improve the user experience for the customer, reduce cost for the customer and the operator by eliminating costly cellular modem and antennas in the home gateway and utilizing the capacities already built into some smartphone devices.

In FIG. 2A, the system 200 in the exemplary embodiment includes a home gateway 202 providing two-way data communication with a broadband provider network 206. The home gateway 202 may establish a local area network 204 and provide access to devices over the local area network to broadband services of the broadband network provider. The system 200 in this example further includes a mobile device 214 which provides data communication with a carrier cellular bootstrap network 216. The system 200 including the home gateway 202, the local area network 204 and the mobile device 214 may be located at any suitable premises 218 such as a customer's residence. In other examples, the premises may include a business space such as a coffee shop or office, a mobile premises such as a recreational vehicle (RV), or an outdoor area where video may be projected or provided.

Generally, the customer is a subscriber to broadband services provided by the broadband provider network 206. Similarly, the customer is a subscriber to wireless services provided by the carrier cellular bootstrap network 216. The customer, in examples, pays a subscription fee to the operator of the broadband provider network 206. The customer further pays a subscription fee to the operator of the carrier cellular bootstrap network 216. The operator of the broadband provider network 206 and the operator of the broadband provider network 206 may be the same entity, affiliated entities or wholly independent. In some examples, the customer may subscribe to service from more than one broadband network provider as well as more than one wireless service provider.

The home gateway 202 is in data communication with the broadband provider network 206 to provide data services to the premises 218. Any suitable services or combination of services may be provided to the home gateway 202 including internet access, streaming services for video and other content, cable television content, telecommunications services such as a telephone line and other services. The home gateway 202 may connect to the broadband provider network 206 using any suitable technology or combination of technologies including fiber optic networks, digital subscriber line (DSL), coaxial cable, satellite and wireless connections.

The home gateway 202 generally includes a broadband modem for data communication with the broadband provider network 206 and a wireless router for establishing the local area network 204 and for providing broadband access to devices over the local area network 204. The modem provides two-way data communication between the home gateway 202 and the broadband provider network 206 over one or more communication media such as fiber optical networks, wireline cable networks and wireless networks. The wireless router may establish the local area network for two-way wireless communication with user devices in an area served by the local area network. The user devices may include in an exemplary embodiment a mobile device 208, a video device such as a television 210, and a tablet computer 212. In an example, the local area network is established as a Wi-Fi network according to any of the IEEE 802.11 family of standards. Referring to FIG. 1, the home gateway 202 may correspond to the access terminal 112 providing broadband access 110 to data terminals 114.

Within the premises 218, the customer or another individual may maintain a wireless device such as mobile device 214. The mobile device 214 provides wireless access to voice service, data service and other services of the carrier cellular bootstrap network 216. The mobile device 214 may be a cellular phone or any other device including a wireless transceiver for radio communication with network equipment of the carrier cellular bootstrap network 216. Referring to FIG. 1, the mobile device may correspond to mobile devices 124 in communication with base station or access point 122 or wireless access 120.

In an embodiment, the mobile device 214 includes an embedded Subscriber Identity Module (eSIM) device 220. The eSIM device 220 is a type of subscriber identify module or SIM. A SIM generally includes a device such as an integrated circuit configured to store particular information or the mobile device 214. Stored information may include an international mobile subscriber identity (IMSI), a unique integrated circuit card identifier (ICCID) and a network authentication key generated by the cellular service provider associated with the SIM. The ICCID may operate to identify the SIM device itself as well as an eSIM profile. The SIM or eSIM is used for identifying and authenticating the mobile device 214 and a subscriber on a mobility network such as the carrier cellular bootstrap network 216.

A SIM may be embodied as a universal integrated circuit card (UICC) which may include a processing system including at least one processor and memory as well and input-output circuits. The eSIM may be installed onto an eUICC chip and be embedded directly into a device such as a cellular phone. The eSIM includes a permanent eSIM identifier (EID) which may be programmed at the time of manufacture of the device containing the eSIM. The EID is used during provisioning to associate the device with an existing carrier subscription. During operation, the EID may be used to negotiate a secure channel for programming. Generally, when a customer or subscriber purchases a new device such as mobile device 214, the SIM is provisioned with information identifying the customer and the device and enabling secure access to the mobility network. An eSIM is a form of programmable SIM that is embedded directly in a device such as mobile device 214. The term eSIM describes the functionality of the SIM and there are multiple eSIM formats.

An eSIM can be provisioned remotely without physically accessing the eSIM on the device. Remote SIM provisioning is a standardized process that allows a device owner to remotely active the SIM embedded in the device. Remote SIM provisioning allows the device owner to choose a mobile network operator to activate the SIM embedded in the device via a subscription.

Generally, wireless service to the mobile device 214 and broadband service to the home gateway from the respective service providers is very reliable. However, service outages do occur from time to time. In the case of the broadband service, an outage may occur for any of a wide variety of reasons such as a severed electrical or optical connection, a storm, etc. Due to such an outage, the customer may lose service through the connection to the broadband provider network 206. During such an outage, the customer does not have access to content delivered over the broadband provider network 206. Moreover, during such an outage, the customer does not have access to the internet. This can be inconvenient for the customer.

It is proposed to provide cellular communication capability that is built in to next-generation home gateway devices. Such a next-generation home gateway device may include a broadband modem and also a cellular modem in combination with a wireless router. Such a device can switch between two different data services for the next-generation home gateway device. That is, if conventional broadband service is interrupted or subject to outage, the cellular modem may be used to access a cellular network such as wireless access 120. The cellular modem can be used to access the internet and content that would normally be accessed over the broadband network. Such an arrangement will minimize inconvenience to the customer and allow the customer to maintain internet access and viewing content and other activities, despite the service outage from the broadband network.

Another approach is to develop an add-on device such as a dongle that is plugged into or externally connected to the next-generation home gateway. The add-on device includes the necessary circuitry to operate as a cellular modem and provide data signals including internet and content from the cellular network to the next-generation home gateway. The add-on device can be activated in the event of a service outage of the broadband network.

However, such integrated products are expensive and have limited cost/benefit for a capability that may never be used. The next-generation home gateway device must be designed and manufactured to include the cellular modem along with the broadband modem. The added components may cost on the order of $150-300. Further, the next generation home gateway device must be designed to selectively switch between use of the cellular modem and the broadband modem according to network availability. Moreover, the customer who has an account for broadband service with the broadband service provider must also maintain an account with the cellular service provider for the backup service.

As indicated, the backup service may never be needed or used. Generally, provision of broadband service is very reliable. Outages occur very rarely. Network availability generally exceeds 99.999 percent. Outages that do occur may occur at times when the customer is not attempting to access the internet or other services. The customer may be completely unaware of the outage. Further, such outages are usually only of short duration, such as a few hours, as the service provider makes repairs and troubleshoots the network. The service provider is highly motivated to get the service back online. Thus, the value added by the built-in cellular modem for backup cellular service for a next generation home gateway may be very limited.

However, most every residence and other premises today has one or more cellular modems already available. Often, each resident or occupant of a premises has a cellular telephone or other mobile device for conventional cellular purposes. Each cellular telephone has a cellular modem that could fulfill the requirements of a backup connection for the home gateway.

Further, some new smartphones and other mobile devices have a capability called Bootstrap. Bootstrap operation is related to eSIM features of a mobile device, particularly to initial remote provisioning of service to the mobile device by the customer. With eSIM on a mobile device, the customer needs to download the eSIM information to the mobile in order to initiate service. However, the mobile device must have data connectivity to the internet in order to download the eSIM information. In many cases, Wi-Fi connectivity is available to provide internet access through a nearby broadband modem, for example. The eSIM information may be downloaded over the Wi-Fi connection and installed on the wireless device. The process can be automated to a great extent.

However, Wi-Fi connectivity is not always available. For example, there may be a service outage on the broadband service that is accessed by the Wi-Fi network. In other examples, not all locations have Wi-Fi connectivity, and some customers such as corporate customers are not allowed to access Wi-Fi networks with employer-issued devices. In such cases, the Bootstrap capability may be used to access the eSIM information.

Some mobile devices include a Bootstrap eSIM. The purpose of the Bootstrap eSIM is to facilitate the download of a carrier-specific eSIM for initial provisioning of the mobile device. The eSIM functionality may also be referred to as Remote SIM Provisioning. Generally, a customer contracts for wireless service with a mobile network operator or carrier and obtains the mobile device. The customer is also given instructions on how to connect the device to the mobile network operator's remote SIM provisioning system. For example, the instructions may include a uniform resource locator (URL) for the remote SIM provisioning system. The URL may be provided in a Quick Response (QR) code. Accessing the website associated with the URL allows the mobile device to connect to the remote SIM provisioning system and securely download SIM profile to the mobile device. Once the SIM profile is installed and activated, the mobile device is able to connect to the carrier's network.

A SIM profile includes network operator data related to a subscription, including the operator's credentials. The SIM profile may further include operator or third-party SIM based applications. The eSIM includes a secure element called the eUICC. The eUICC can accommodate multiple profiles. Profiles are remotely downloaded over-the-air into a eUICC.

After initial provisioning, the eSIM is installed on the mobile device, it is provisioned for service, it is actively running, it has a unique access point name (APN) and a unique billing relationship with the mobility network operator that is outside of the customer's view. In an example, the mobility network operator charges the device manufacturer for the bootstrap capability that is installed in the manufacturer's devices.

In embodiments, the Bootstrap service may be used to maintain continuity in the event mainline broadband service becomes unavailable at a premises. The Bootstrap service may be used to serve the home broadband. Rather than using the subscriber's primary access point name (APN), referring to the regular cellular service for which the subscriber pays, the Bootstrap service associated with a mobile device of the user may be used to replace the broadband service in the event the fiber network, DSL or cable connection becomes unavailable.

It is known to use a cellular device as a hotspot to provide a data connection for devices in an area near the cellular device. For example, a cellular device may establish a local area network using an IEEE 802.11 Wi-Fi radio of the cellular device. The cellular device has an internet connection over the cellular network to the cellular service provider. Devices such as a personal computer, a printer, a television, etc., can access the local area network and thereby access the internet through the access point of the cellular device.

In accordance with aspects described herein, rather than accessing the cellular network using the main data APN, the cellular device uses the Bootstrap eSIM service to access the cellular network and provide services in place of the unavailable broadband network. The provision of broadband services through the eSIM service may be only temporary, during unavailability of the broadband network.

FIG. 2B depicts an illustrative embodiment of a method 230 in accordance with various aspects described herein. The method 230 may be used in conjunction with a Bootstrap eSIM service to provide data services to a premises during times when normally-available broadband services are unavailable.

Initially, access to the Bootstrap eSIM service must be established for a mobile device such as a smartphone. Some wireless devices are sold with an eSIM capability and include a Bootstrap eSIM. If the wireless device is initially activated and no Wi-Fi or other connection to a cellular network is available the Bootstrap eSIM service contacts the cellular network and downloads eSIM information for the carrier and the subscriber.

In accordance with method 230, the Bootstrap eSIM service may be extended to include broadband backup capability. Accordingly, at step 232 a customer who owns a Bootstrap-enables wireless device such as a smartphone registers for the Bootstrap backup service with the cellular service provider. Service entitlement for use of the broadband backup via bootstrap service can be tied to the customer's cellular smartphone plan. The service can be entitled during a device to network communication. Entitlement is a function for device to network communication for eligibility and feature provisioning. During the entitlement process, the wireless device may communicate, for example, with an entitlement server of the cellular service provider. The customer arranges for the Bootstrap backup service as part of a service subscription plan, for example. The entitlement process confirms that the customer is authorized to use the service and has paid for the service, if appropriate, as part of the subscription plan.

Initiating the service may include a process of establishing a local area connection between the customer's wireless device and the home gateway at the premises of the customer. In an example, the wireless device, in addition to a cellular modem for communication with the cellular network, also includes a IEEE 802.11 Wi-Fi modem for establishing a local area network with the wireless device operating as a hotspot. The wireless device can relay communications between the cellular network and devices on the local area network. Such devices may include the home gateway and one or more televisions or other video devices.

At step 234, a communication from the smartphone or other wireless device having a Bootstrap eSIM service capability is made to establish the service. Provisioning information may be exchanged as well as information about broadband subscriptions of the customer that are normally accessed through the home gateway over the broadband network.

At step 236, a broadband network failure occurs. The failure may be due to any reason such as a disrupted data connection, equipment failure, etc. In response to the service disruption, the Bootstrap backup service is initiated. The home gateway recognizes the failure of the broadband network. The home gateway maintains a Wi-Fi connection to all connected devices such as a television, the wireless device and other devices on the local area network. However, the home gateway has lost its backhaul connection because the broadband connection is interrupted. In many cases, the wireless device makes use of the broadband network via a Wi-Fi connection and will recognize the outage as well.

At step 238, it is determined if this was the initial broadband failure and the initial attempt to initiate the backup service using the Bootstrap eSIM service of the wireless device. If so, control proceeds to block 240 where the customer manually activates the service, such as by using an application program (app) on the customer's wireless device. The app or another process may interact with an entitlement server of the cellular network provider to confirm that the user is entitled to use the Bootstrap backup service. This interaction may initiate the service between the user and the cellular network provider, such as beginning account billing for the service.

If this is not the initial broadband failure and usage of the Bootstrap eSIM service, control proceeds to block 242 in which the home gateway and the wireless device automatically make a connection over Wi-Fi local area or other available local connection. Further, the wireless device automatically initiates the Bootstrap eSIM service with the cellular network.

As indicated, some smartphones and other wireless devices are sold with a Bootstrap eSIM. Conventionally, the Bootstrap eSIM is used only when the device is first activated and when no other network is available, such as a Wi-Fi network. The Bootstrap eSIM includes sufficient information for the wireless device to access the cellular network and provide a data service to download a working eSIM for the ongoing operation of wireless device. After the wireless device is first activated, the working eSIM is used to provide necessary authentication and access to the network whenever the wireless device accesses the network thereafter. However, the Bootstrap eSIM remains present in the wireless device. The method 230 and other aspects herein make a new use of the Bootstrap eSIM by activating the Bootstrap eSIM to provide a backup access to the cellular network and data services at times when a separate broadband connection to the home gateway is unavailable. The Bootstrap eSIM service is not part of the subscription plan of the owner of the wireless device. Usage of the Bootstrap eSIM service may be separately billed to the subscriber or may be packaged with other features in a subscription plan.

At step 244, the home gateway begins receiving data services through the Bootstrap eSIM service of the smartphone or other wireless device. The user may access the internet via a data connection of the cellular network. Similarly, the user may access third party data services and content services using the data connection of the cellular network. In an example, the cellular network is a fifth generation (5G) cellular network and includes a radio access network and a core network. The radio access network provides radio connection between the customer's wireless device and the core network. The core network includes a variety of functions including a network gateway to the public internet. In this manner, the home gateway, television and other devices on the hotspot formed by the user's wireless device can access data services and other online services through the cellular network when the broadband network to the home gateway is unavailable.

At step 246, it is determined if the broadband network is now available or still unavailable. This may be done in any convenient fashion, such as the home gateway testing for receipt of data or communicating with a head end of the broadband network. If the broadband network is still unavailable, the method 230 may remain in a loop including step 244 and step 246 until the broadband network becomes available.

Once the broadband network becomes available again, at step 248, the connection through the Bootstrap eSIM service to the cellular connection is dropped and control is returned to the broadband network. The home gateway and other local devices resume receiving content and other data over the broadband network. The backup connection to the cellular network, using the Bootstrap eSIM service, is used only as a backup, when the conventional broadband network is unavailable.

The system 200 and the method 230 provide a number of significant advantages for a user. First, the illustrated examples provide a cost-effective backup capability for broadband services. Currently available equipment may be used without modification, such as by adding a cellular modem to a home gateway. This reduces cost and complexity for the home gateway device and for the network operator, and reduced cost for the customer. For the customer, having a cellular network, such as a 5G cellular network, available for backup ensures that the customer is on the fastest and most reliable network in their home. The cellular service provider benefits by having an additional product to offer to customers. The broadband bootstrap backup service can be offered to customers as an additional feature or an extension of a current subscription. Reliable availability of online services, with backup available when necessary, can greatly improve experience for customers, including those who work from home and need reliable network access at all times.

While for purposes of simplicity of explanation, the respective processes are shown and described as a series of blocks in FIG. 2B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

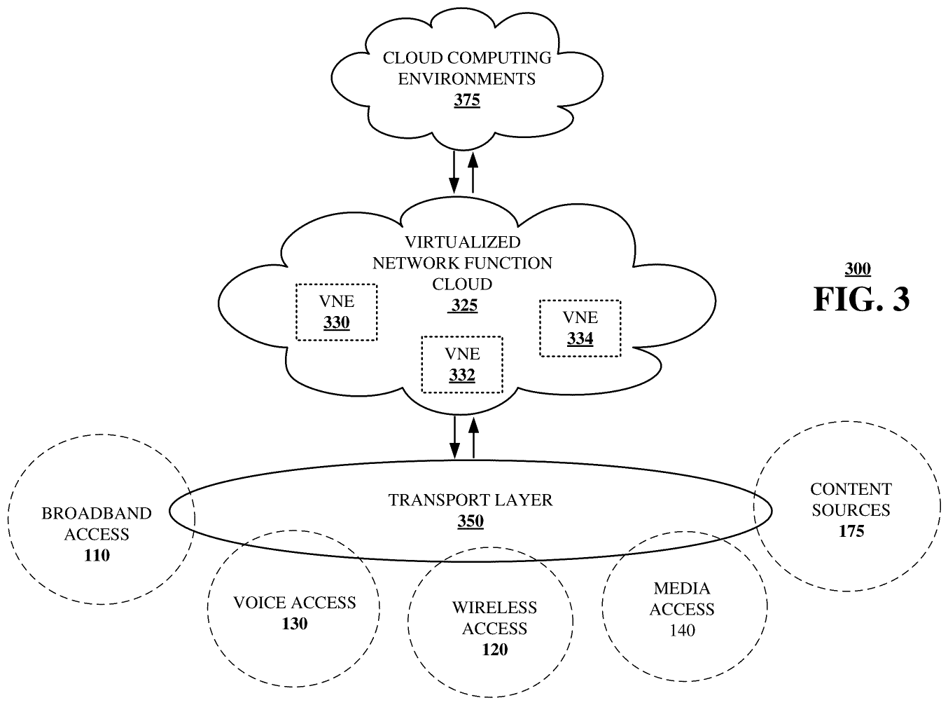

Referring now to FIG. 3, a block diagram of a communication network 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200, and method 230 presented in FIG. 1, FIG. 2A, FIG. 2B, and 3. For example, virtualized communication network 300 can facilitate in whole or in part using a Bootstrap eSIM of a wireless device to provide backup data services to a home gateway when a broadband network serving the home gateway becomes unavailable.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

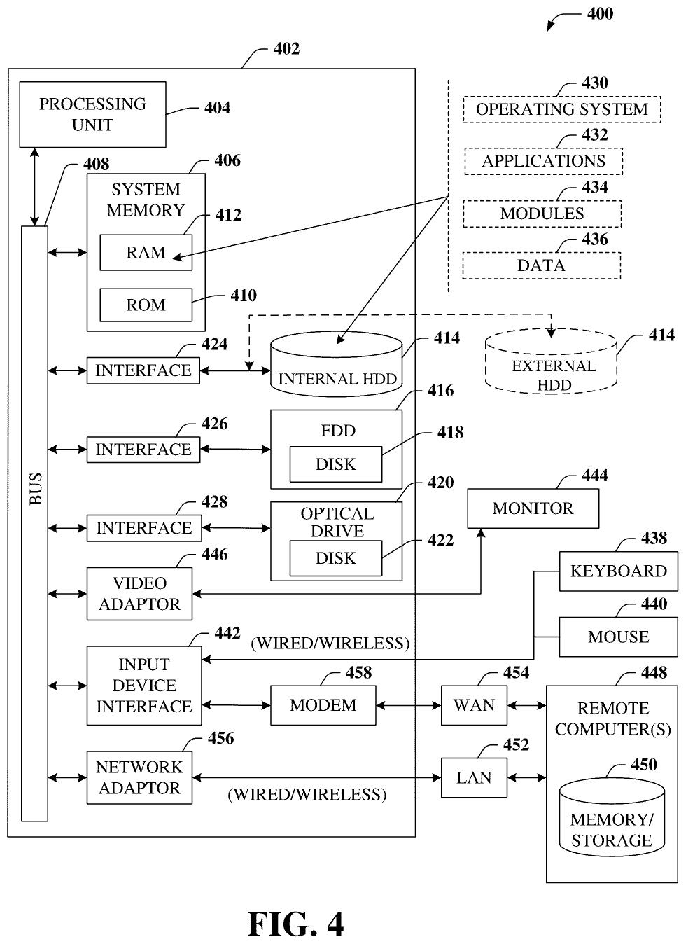

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part using a Bootstrap eSIM of a wireless device to provide backup data services to a home gateway when a broadband network serving the home gateway becomes unavailable.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

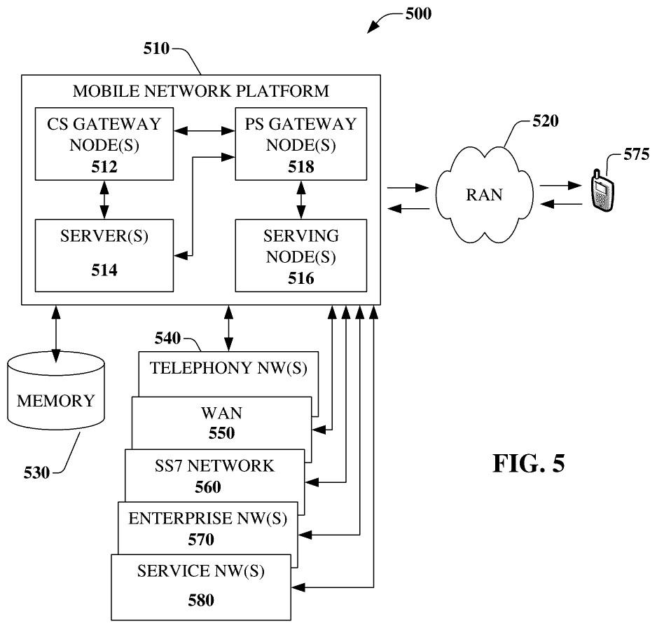

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part using a Bootstrap eSIM of a wireless device to provide backup data services to a home gateway when a broadband network serving the home gateway becomes unavailable. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technologies utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

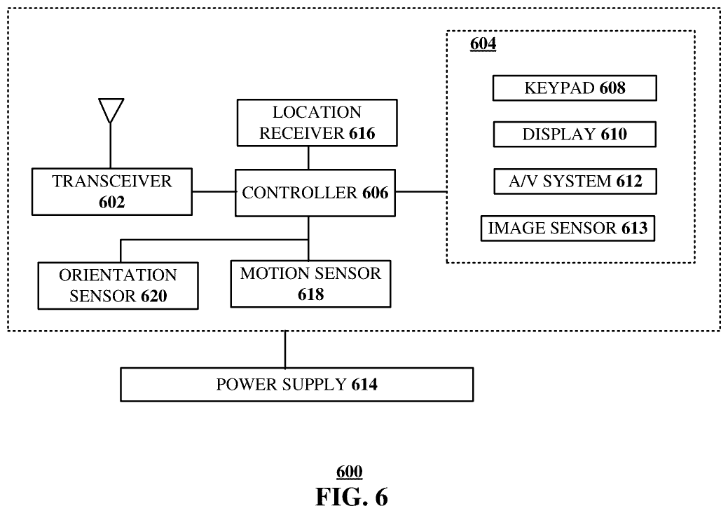

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part using a Bootstrap eSIM of a wireless device to provide backup data services to a home gateway when a broadband network serving the home gateway becomes unavailable.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VOIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A wireless device, comprising:
a processing system including a processor; and
a memory that stores executable instructions that, when executed by the processing system, facilitate performance of operations, the operations comprising:
establishing a local area connection with one or more devices including a home gateway, the home gateway configured to access data services over a broadband network;
receiving an indication that the data services over the broadband network are unavailable;
initiating a cellular network connection with a cellular network using a Bootstrap embedded subscriber identity module (eSIM) service of the wireless device to access the cellular network; and
providing backup data services to the one or more devices over the cellular network according to the Bootstrap eSIM service.

2. The wireless device of claim 1, wherein the operations further comprise:
receiving a second indication that the data services over the broadband network are again available; and
discontinuing the providing backup data services to the one or more devices over the cellular network according to the Bootstrap eSIM service.

3. The wireless device of claim 1, wherein the operations further comprise:
communicating with an entitlement server to register for the providing backup data services over the cellular network.

4. The wireless device of claim 1, wherein the operations further comprise:
determining the providing the backup data services is a first time for providing the backup data services; and
communicating with an entitlement server to register for the providing backup data services over the cellular network, wherein the communicating with the entitlement server is responsive to the determining the providing the backup data services is a first time for providing the backup data services.

5. The wireless device of claim 1, wherein the providing backup data services comprises:
providing a content item from a third-party content provider to a video device, wherein the video device is in data communication with the wireless device over the local area connection.

6. The wireless device of claim 1, wherein the providing backup data services comprises:
providing internet access to one or more websites for a computer device, wherein the computer device is in data communication with the wireless device over the local area connection.

7. The wireless device of claim 1, wherein the establishing a local area connection with one or more devices including a home gateway comprises:
initiating a Wi-Fi local area network;
establishing the wireless device as a hotspot in data communication with the Wi-Fi local area network; and
adding the one or more devices to the Wi-Fi local area network.

8. The wireless device of claim 1, wherein the receiving an indication that the data services over the broadband network are unavailable comprises:
receiving, from the home gateway, an indication that the home gateway is no longer in data communication with a device of the broadband network.

9. The wireless device of claim 1, wherein the operations further comprise:
initiating an initial operation of the wireless device;
accessing a Bootstrap eSIM device of the wireless device;
based on information of the Bootstrap eSIM device, establishing a data session with the cellular network;
receiving a carrier-specific eSIM for initial provisioning of the wireless device; and
subsequently, accessing the carrier-specific eSIM for establishing subsequent data sessions of the wireless device with the cellular network.

10. The wireless device of claim 9, wherein the operations further comprise:
accessing the Bootstrap eSIM device in response to the indication that the data services over the broadband network are unavailable;
based on information of the Bootstrap eSIM device, establishing a broadband backup data session with the cellular network; and
providing the backup data services to the one or more devices over the cellular network based on the information of the Bootstrap eSIM device.

11. A non-transitory machine-readable medium, comprising executable instructions that, when executed by a processing system including a processor, facilitate performance of operations, the operations comprising:
initiating a wireless local area network with one or more devices;
providing broadband data services to the one or more devices over the wireless local area network, wherein the providing broadband data services comprises communicating data with a broadband network;
identifying a failure in the communicating data with the broadband network;
automatically initiating a hotspot connection with a wireless device; and
providing backup broadband services to the one or more devices over the wireless local area network from the hotspot connection with the wireless device, wherein the wireless device is operative to establish a cellular network connection with a cellular network using a Bootstrap embedded subscriber identity module (eSIM) service of the wireless device to access the cellular network.

12. The non-transitory machine-readable medium of claim 11, wherein the operations further comprise:
determining that data communication with the broadband network has resumed following the failure in the communicating data;
resuming the providing broadband data services to the one or more devices over the wireless local area network; and
terminating the hotspot connection with the wireless device.

13. The non-transitory machine-readable medium of claim 11, wherein the providing broadband data services to the one or more devices over the wireless local area network comprises:
requesting one or more streaming content items from a third-party content provider over the broadband network; and
providing the one or more streaming content items from the broadband network to the one or more devices over the wireless local area network.

14. The non-transitory machine-readable medium of claim 13, wherein the providing backup broadband services comprises:
requesting the one or more streaming content items from the third-party content provider over the cellular network; and
providing the one or more streaming content items from the cellular network and the hotspot connection with the wireless device to the one or more devices over the wireless local area network.

15. The non-transitory machine-readable medium of claim 11, wherein the wireless device is operative to access a Bootstrap eSIM device of the wireless device and, based on information of the Bootstrap eSIM device of the wireless device, establish a Bootstrap data session with the cellular network and wherein the operations further comprise:
receiving, from the wireless device over the hotspot connection, content data from the cellular network connection with the cellular network.

16. The non-transitory machine-readable medium of claim 15, wherein the initiating a hotspot connection with a wireless device comprises:
accessing a Wi-Fi network established by the wireless device.

17. A method, comprising:
establishing, by a processing system including a processor of a wireless device, a hotspot network with one or more devices including a home gateway, the home gateway configured to access broadband data services over a broadband network;
receiving, by the processing system, from the home gateway, an indication that the broadband data services are unavailable;
accessing, by the processing system, a Bootstrap eSIM of the wireless device, wherein the accessing the Bootstrap eSIM is responsive to the receiving the indication that the broadband data services are unavailable;
initiating, by the processing system, a cellular network connection with a cellular network, wherein the initiating the cellular network connection is based on information of the Bootstrap eSIM; and
providing, by the processing system, backup data services from the cellular network to the home gateway over the hotspot network.

18. The method of claim 17, comprising:
receiving, by the processing system, backup data over the cellular network for the one or more devices, wherein the backup data comprises data from the broadband data services over the broadband network prior to the indication that the broadband data services are unavailable.

19. The method of claim 17, comprising:
communicating, by the processing system, with an entitlement server to register for a Bootstrap eSIM service, the Bootstrap eSIM service available to the wireless device according to a service subscription of the wireless device.

20. The method of claim 17, comprising:
receiving, by the processing system, a second indication that the broadband data services are again available over the broadband network; and
terminating the cellular network connection with a cellular network.
